(19) United States
(12) Patent Application Publication
(10) Pub. No.: US 2025/0055138 A1
(43) Pub. Date: Feb. 13, 2025

(54) ELECTROCHEMICAL BUNDLE, BATTERY CELL AND ASSOCIATED MANUFACTURING METHODS

(71) Applicant: SAFT, LEVALLOIS PERRET (FR)

(72) Inventors: Gérard RIGOBERT, FARGUES ST HILAIRE (FR); Alexandre NARBONNE, BLANQUEFORT (FR)

(73) Assignee: SAFT, LEVALLOIS PERRET (FR)

(21) Appl. No.: 18/722,657

(22) PCT Filed: Dec. 20, 2022
(86) PCT No.: PCT/EP2022/086899

§ 371 Date: Jun. 21, 2024

(30) Foreign Application Priority Data
Dec. 22, 2021 (FR) FR2114203

(51) Int. Cl. H01M 50/474; B23K 31/02; H01M 10/0585; H01M 50/477; H01M 50/483; H01M 50/536; H01M 50/54

(52) U.S. Cl. CPC H01M 50/474; B23K 31/02; H01M 10/0585; H01M 50/477; H01M 50/483; H01M 50/536; H01M 50/54

(57) ABSTRACT

The invention relates to an electrochemical bundle comprising a plurality of stacks each including a first polarity electrode, a second polarity electrode, a first separator and a second separator. Each first polarity electrode comprises an electrical connection tab.

The electrochemical bundle comprises a first metallic separator interposed between each pair of adjacent electrical connection tabs. The first separator is attached to at least one of said electrical connection tabs.

The first separator extends, between each pair of adjacent electrical connection tabs, between a lower edge and an upper edge.

The upper edges of the first separator are substantially flush with the upper edges of the electrical connection tabs.

### CROSS REFERENCE TO RELATED APPLICATIONS

The present application is a U.S. National Phase Application under 35 U.S.C. § 371 of International Patent Application No. PCT/EP2022/086899 filed Dec. 20, 2022, which claims priority of French Patent Application No. 21 14203 filed Dec. 22, 2021. The entire contents of which are hereby incorporated by reference.

### FIELD OF THE INVENTION

According to a first aspect, the present invention relates to an electrochemical bundle comprising a plurality of stacks, stacked according to a stacking direction,
each stack including a first polarity electrode, a second polarity electrode, a first separator and a second separator, the second polarity electrode being interposed between the first separator and the second separator, the second separator being interposed between the first polarity electrode and the second polarity electrode,
the first polarity electrode comprising a flat collector, an electrical connection tab and a layer including an active material covering at least one face of the collector,
the electrical connection tab being devoid of the layer including the active material, and projecting from an upper edge of the collector, the electrical connection tab extending between the upper edge of the collector and an upper edge according to a vertical direction substantially perpendicular to the stacking direction.

This invention is particularly applicable to electrochemical battery cells that use negative electrodes based on lithium titanium oxide (LTO) or niobium titanium oxide (TNO), graphite, silicon, lithium metal or alloy, or any other active material that does not present a risk of lithium deposition and hence dendrite formation due to its high operating potential. This invention is also applicable to electrochemical battery cells using positive electrodes based on nickel, manganese, and cobalt lithium oxide (NMC), nickel cobalt aluminum lithium oxide (NCA), lithium iron phosphate (LFP) or mixed lithium iron manganese phosphate (LMFP).

### BACKGROUND

To recover voltage and current, the electrochemical bundle 102 is connected at its upper part to the terminals 104 of the prismatic element via welding on the metal connectors 106.

To this end, when closing the cover of the battery cell 100, in order to maximize the space occupied by the active material in the element, and the electrical capacity of the element 100, the cover which closes the battery cell is likely to exert a stress on the connection, and consequently, on the electrode tabs 108.

As shown in FIG. 1, these therefore are bent back toward the stack, generally adopting a curved configuration. In this configuration, the tabs 108 of the positive electrodes, which are not coated with the layer including the active material, are arranged close to the upper edges of the negative electrode collectors. Similarly, the tabs 108 of the positive electrodes, which are not coated with the layer including the active material, are arranged close to the upper edges of the positive electrode collectors.

Normally, the separator arranged between each pair of facing positive and negative electrodes is interposed between each tab of a positive electrode and the upper edge of the facing negative electrode, and between each tab of a negative electrode and the upper edge of the positive electrode.

However, given the compression within the element and the presence of the layer including the active material up to the upper edge of each negative electrode, there remains a substantial risk of short-circuiting in the event of poor insulation, particularly if the separator does not form a screen, or if the electrical connections are tightly packed. This reduces the reliability of the battery cell.

To alleviate this problem, it is known to coat the base of the positive electrode tabs with a protective insulating coating such as a plastic or ceramic coating. However, this solution complicates the manufacturing process and increases cost.

Furthermore, in this type of battery cell, the zone where the tabs are bent, occupies a large space in the upper part of the cup, limiting the dimensions of the electrodes inside the cup and consequently the capacity of the battery cell.

### SUMMARY

One aim of the invention is therefore to provide an electrochemical bundle for a battery cell that is reliable in use and allows the electrical capacity and compactness of the battery cell to be optimized.

To this end, the subject matter of the invention is an electrochemical bundle, such as defined above, wherein the electrochemical bundle further comprises a first metallic separation device interposed between each pair of adjacent electrical connection tabs according to the stacking direction, the first separation device being attached to at least one of said electrical connection tabs,
the first separation device extending, between each pair of adjacent electrical connection tabs, between a lower edge and an upper edge according to the vertical direction,
   the upper edges of the first separation device being substantially flush with the upper edges of the electrical connection tabs of the first polarity electrodes.

Thus, the upper edges of the electrical connection tabs and the upper edges of the first separation device define a surface suitable for welding an electrical connector. The first separation device allows to densify and stiffen the upper part of the electrical connection tabs, making the step of welding the electrical connector easier.

Therefore, there is no need to bend the electrical connection tabs in the upper part of the cup. The height of the tabs is therefore reduced, which allows the dimensions of the electrodes to be increased and thus increase the capacity of the battery cell for the same cup size.

The electrochemical bundle may comprise one or more of the following features, taken individually or according to any technically possible combination:
the height of the electrical connection tab relative to the upper edge of the collector is less than 5 mm, preferably between 1 mm and 5 mm;
each pair of adjacent electrical connection tabs delimits between them a gap receiving the first separation device, the width of the first separation device between the adjacent electrical connection tabs, taken according to the stacking direction, being at least equal to 60% of the width of the gap;
the lower edges of the first separation device are spaced apart, according to the vertical direction, from the upper edges of the collectors of the first polarity electrodes of the plurality of stacks;
the first separation device is welded to the electrical connection tab by at least one weld;
the weld is a laser weld or an ultrasonic weld;
each electrical connection tab extends between a first lateral edge and a second lateral edge according to a horizontal direction substantially perpendicular to the vertical direction and the stacking direction, the first separation device being a continuous metal strip successively surrounding the first lateral edge of one electrical connection tab and the second lateral edge of an adjacent electrical connection tab; and
the first electrical connection device comprises a plurality of metallic separation members, distinct from one another, interposed respectively between each pair of adjacent electrical connection tabs, each separation member extending between a lower edge and an upper edge according to the vertical direction, the upper edges of the first separation device being formed by the upper edges of the various separation members.

The invention also has its object a battery cell comprising:
a cup or pouch delimiting an internal volume,
at least one electrochemical bundle, such as described above, arranged in the internal volume,
at least one first electrical connector welded to the upper edges of the electrical connection tabs of the first polarity electrodes and to the upper edges of the first separation device.

The invention also relates to a method for manufacturing an electrochemical bundle as described above, the method comprising:
successively depositing the stacks according to the stacking direction,
interposing the first separation device between each pair of adjacent electrical connection tabs,
attaching the first separation device to at least one of said electrical connection tabs,
the plurality of upper edges of the first separation device being substantially flush with the upper edges of the electrical connection tabs of the first polarity electrodes.

According to one particular embodiment, the method comprises the following feature: attachment of the first separation device to the electrical connection tab is carried out by welding.

The invention also has as its object a battery cell manufacturing method comprising the following steps:
manufacturing an electrochemical bundle according to the method described above,
inserting the electrochemical bundle into an internal volume of a cup or pouch,
welding at least one first electrical connector to the upper edges of the electrical connection tabs of the first polarity electrodes and to the upper edges of the first separation device.

### BRIEF DESCRIPTION OF THE DRAWINGS

The invention will be better understood on reading the following description, given by way of example, and made with reference to the appended drawings, in which:

FIG. 1 is a perspective view of a battery cell of the state of the art,

FIG. 2 is a perspective view of a battery cell according to a first embodiment of the invention,

FIGS. 3 and 4 are schematic partial perspective and sectional views of the negative electrodes of the electrochemical bundle of the battery cell of FIG. 2,

FIG. 5 is a partial schematic view of a method for manufacturing an electrochemical bundle of the battery cell of FIG. 2, and

FIG. 6 is a perspective view of the negative electrodes of an electrochemical bundle according to a second embodiment of the invention.

### DETAILED DESCRIPTION

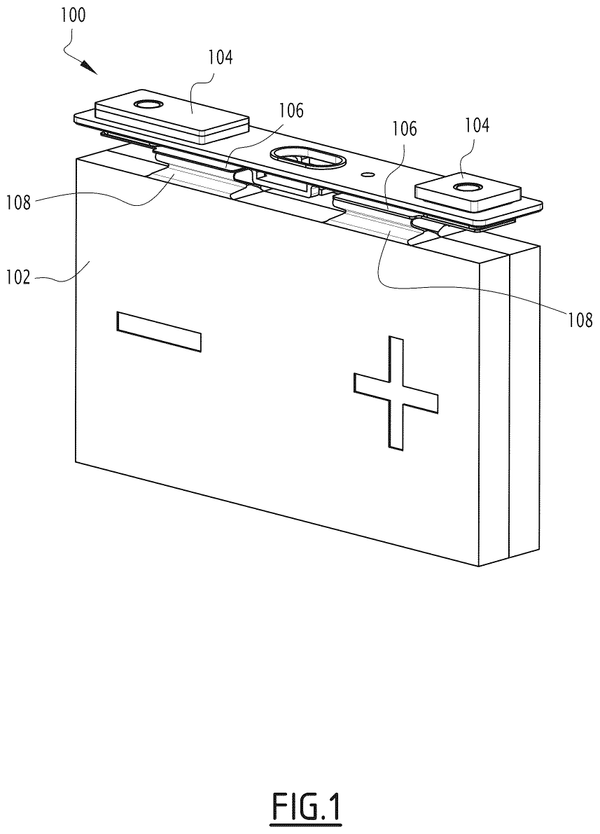

FIG. 1 illustrates an example of a battery cell 100 of the state of the art comprising such an electrochemical bundle 102.

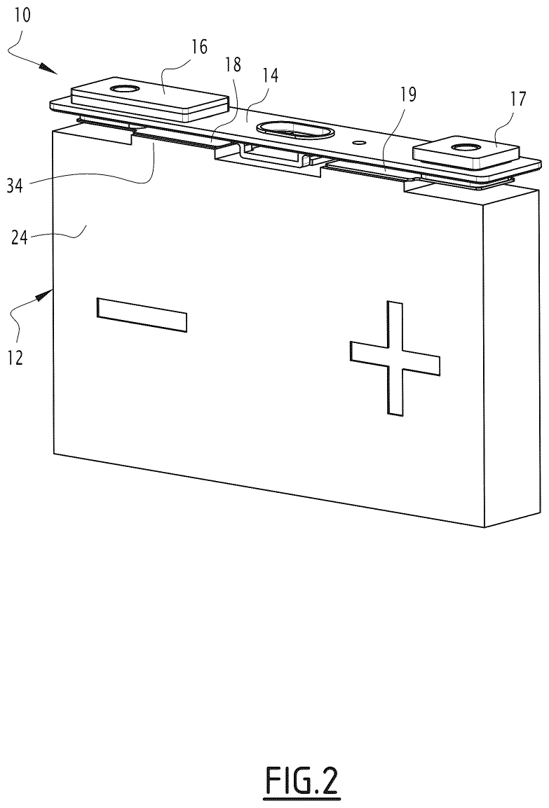

FIG. 2 illustrates a battery cell 10 according to a first embodiment of the invention.

The battery is an electrochemical battery such as typically used in rail vehicles or aircraft. Other fields of application for the battery are conceivable, such as motor vehicles, energy storage systems or electric mobility.

The battery cell 10 according to the invention includes a housing or cup (not shown) defining an internal volume and at least one electrochemical bundle 12 arranged within the internal volume of the cup.

The battery cell includes a lid 14 closing the internal volume of the cup, a first polarity terminal 16, here negative, a second polarity terminal 17, here positive, a first electrical connector 18 and a second electrical connector 19 electrically connecting the electrochemical bundle 12 to the first polarity terminal 16 and the second polarity terminal 17 respectively, both accessible on the lid 14.

The cup includes a bottom wall, and a side wall projecting from the bottom wall to delimit the internal volume.

The cup is preferably parallelepiped, in particular a rectangular parallelepiped. The internal volume of the cup opens out through an access opening which opens toward the top when the bottom wall is placed on a horizontal collector.

In all that follows, orientations are defined with reference to the cup resting on a horizontal surface, with its bottom wall in contact with the horizontal surface. The terms “top”, “bottom”, “upper”, “lower”, “horizontal”, “vertical” extend relative to this orientation.

The lid 14 is intended to be fixed on the cup to close the internal volume toward the top.

Each electrochemical bundle 12 is received in the internal volume. Preferably, the volume occupied by the electrochemical bundle(s) 12 is greater than 70% of the internal volume.

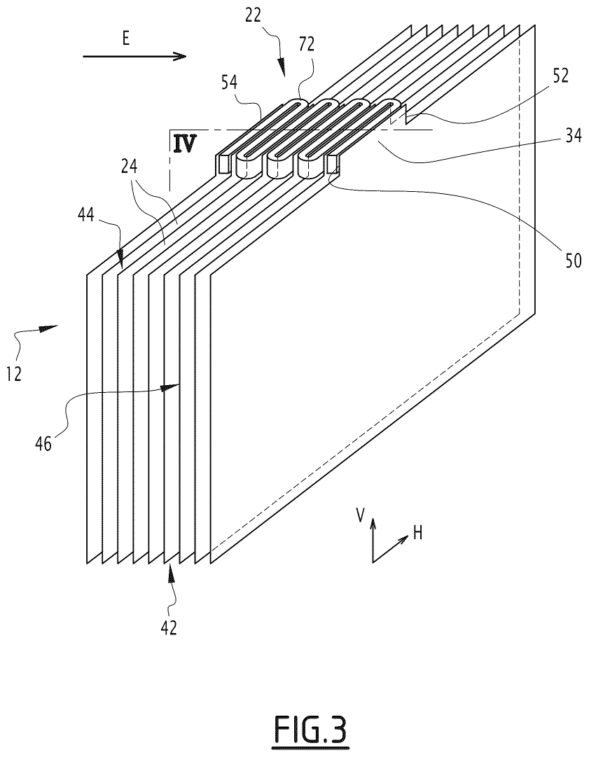

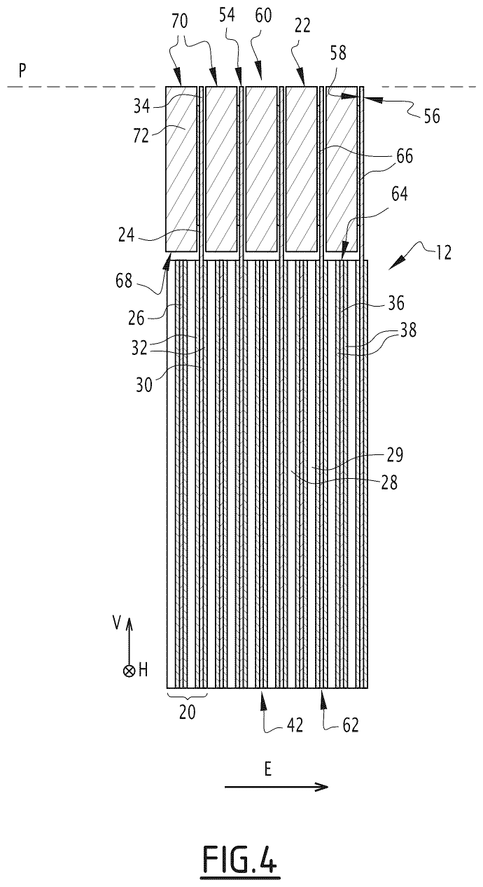

With reference to FIGS. 3 and 4, each electrochemical bundle 12 comprises a plurality of successive stacks 20 stacked according to a stacking direction E, and at least a first metal separation device 22.

Each stack 20 comprises a first polarity electrode 24, in particular a negative electrode, a second polarity electrode 26, in particular a positive electrode, a first separator 28 and a second separator 29. The second polarity electrode 26 is interposed between the first separator 28 and the second separator 29. The second separator 29 is interposed between the first polarity electrode 24 and the second polarity electrode 26.

Each electrochemical bundle 12 is, in addition, immersed in an electrolyte, present in the internal volume to impregnate the electrodes 24, 26, the first separator 28 and the second separator 29.

With particular reference to FIG. 4, the first polarity electrode 24, here the negative electrode, includes a flat collector 30, a layer 32 including an active material covering the collector 30 and an electrical connection tab 34 projecting toward the top, according to a vertical direction V substantially perpendicular to the stacking direction E, relative to the collector 30 to allow connection to the first electrical connector 18.

Similarly, the second polarity electrode 26, here, the positive electrode, also includes a flat collector 36, a layer 38 including an active material covering the collector 36 and an electrical connection tab projecting toward the top from the collector 36 to allow connection to the second electrical connector 19.

The collector of each electrode 24, 26 is preferably metallic, for example, copper or aluminum according to the polarity of the electrode 24, 26. It constitutes a current collector. It is formed, for example, of a strip, particularly a thin strip presenting a thickness of less than 20 μm.

The collector 30 of each of the first polarity electrodes 24 presents, for example, a substantially polygonal contour, in particular a rectangular contour. It extends according to the vertical direction V, between a lower edge 42 and an upper edge 44, substantially perpendicular to the stacking direction E. It extends according to a horizontal direction H, substantially perpendicular to the vertical direction V and to the stacking direction E, between a first lateral edge 46 and a second lateral edge (not shown). The first lateral edge 46 is located at a distance closer to the tab 34 than the second lateral edge 48.

The upper edge 44 extends on either side of the tab 34, which projects from the upper edge 44. The height according to the vertical direction V to which the upper edge 44 extends relative to the lower edge 42 is preferably identical on both sides of the tab 34.

The tab 34 is preferably integrally made with the collector 30. The tab 34 is thus obtained during the production of the collector 30.

The tab 34 here presents a polygonal contour, for example, a rectangle or square. The tab 34 extends according to the horizontal direction H between a first lateral edge 50 connected to the upper edge 44 of the collector 30, and a second lateral edge 52, also connected to the upper edge 44 of the collector 30. The tab 34 in addition extends between the lower edge 42 of the collector 30 and an upper edge 54 according to the vertical direction V, connecting the first lateral edge 50 and the second lateral edge 52. The upper edge 54 defines at least one substantially flat surface.

The height of the tab 34 taken relative to the upper edge 44 of the collector 30 is preferably less than 3 mm, more preferably between 1 mm and 5 mm.

The tab 34 defines a first face 56 and a second face 58 substantially parallel to the first face 56. The second face 58 is arranged opposite the first face 56. The first face 56 and the second face 58 each extend in planes substantially perpendicular to the stacking direction E.

As visible in FIG. 3, the tabs 34 are arranged side by side according to the stacking direction E, with the first face 56 of one tab 34 being arranged facing the second face 58 of an adjacent tab 34 according to the stacking direction E. Advantageously, the tabs 34 are all identical to each other.

Each tab 34 is spaced from an adjacent tab 34, according to the stacking direction E, by a gap 60. The gap 60 is defined between the first face 56 of one tab 34 and the second face 58 of the adjacent tab 34.

In the illustrated example, the width of the gap 60 taken according to the stacking direction E, in other words, the distance between the first face 56 of a tab 34 and the second face 58 of the adjacent tab 34, is equal to the sum of the widths of the second polarity electrode 26, here positive, the first separator 28, the second separator 29, and the two layers 32 of material including the active material covering one face of each of the collectors 30 of two adjacent first polarity electrodes 24.

The layer 32 including the active material covers the whole of at least one face of the collector 30, vertically between the lower edge 42 and the upper edge 44, and horizontally between the first lateral edge 46 and the second lateral edge 48. It does not cover the tab 34, which remains bare.

The active material is, for example, a lithium or lithium-capable titanium oxide (or “LTO”), or a niobium titanium oxide (or “TNO”) or a mixture of these two compounds (LTO/TNO), graphite, silicon, lithium metal or an alloy.

Alternatively, the active material comprises one or more of the following compounds: nickel manganese cobalt lithium oxide (NMC) of the formula Li(NiₓMn_{y}Co_{z})O₂, nickel cobalt aluminum lithium oxide (NCA) of the formula Li(NiₓCo_{y}Al_{1-x-y})O₂, lithium iron phosphate (LFP) of the formula LiFePO₄, mixed lithium iron manganese phosphate (LMFP) of the formula LiFeₓMn₁₋ₓPO₄ and/or lithium nickel manganese oxide (LNMO).

The collector 36 of each of the second polarity electrodes 26 presents, for example, a substantially polygonal contour, in particular a rectangular contour. It extends according to the vertical direction V between a lower edge 62 and an upper edge 64. It extends according to the horizontal direction H between a first lateral edge and a second lateral edge. The first lateral edge is located at a distance further away from the tab than the second lateral edge.

The upper edge extends on either side of the tab, which projects from the upper edge. The height at which the upper edge extends relative to the lower edge is preferably identical on both sides of the tab.

The tab is preferably integrally made with the collector 36. The tab is thus obtained during the manufacture of the collector 36.

The tab presents a polygonal contour, for example, a rectangle or square. The tab extends horizontally between a first lateral edge connected to the upper edge 64 of the collector 36, and a second lateral edge, also connected to the upper edge 64 of the collector 36. The tab further defines an upper edge connecting the first lateral edge and the second lateral edge. The upper edge defines at least one substantially flat surface.

The height of the tab taken relative to the upper edge of the collector 36 is preferably less than 3 mm, preferably between 1 mm and 5 mm.

The height of the tab of the second polarity electrodes 26 is preferably substantially identical to the height of the tab 34 of the first polarity electrodes 24.

The tab defines a first face and a second face substantially parallel to the first face, arranged opposite the first face.

In a similar way to the tabs 34 of the first polarity electrodes 24, the tabs of the second polarity electrodes 26 are arranged next to each other according to the stacking direction E, facing each other. Advantageously, they are all identical.

Each tab is spaced from an adjacent tab, according to the stacking direction E, by a gap. The gap is defined between the first face of one tab and the second face of the adjacent tab.

The width of the gap taken according to the stacking direction E, in other words, the distance between the first face of one tab and the second face of the adjacent tab, is equal to the sum of the widths of the first polarity electrode 24, here negative, the first separator 28, the second separator 29, and two layers 32 of material including the active material covering each of the collectors 36 of two adjacent electrodes 26.

The layer 32 including the active material covers the whole of at least one face of the collector 36, vertically between the lower edge 62 and the upper edge 64, and horizontally between the first lateral edge and the second lateral edge. It does not cover the tab, which remains bare.

The tabs 34 of the electrodes 24 of the first polarity, here negative, are arranged at a distance from the tabs of the electrodes of the second polarity 26, here positive, according to the horizontal direction H.

Each of the first and second separators 28, 29 formed of one or more foil sheets, preferably one or more electrically insulating foil sheets. Each foil is formed, for example, of a sheet of polymeric material, in particular polyolefin foil, which is preferably permeable to lithium ions.

The first separator 28 and the second separator 29 are preferably identical to each other.

The thickness of each of the first and second separators 28, 29 is, for example, less than 25 μm.

The electrolyte is, for example, liquid. For example, it is formed from an organic electrolyte containing only lithium salts, such as LiPF₆, and solvents. Alternatively, the electrolyte is in the form of a solid or gel, for example based on polyvinylidene fluoride (PVDF) polymers or a copolymer of polyvinylidene fluoride and hexafluoropropylene (PVDF-HFP), as well as solvents or salts.

Preferably, the electrochemical bundle comprises a first metallic separation device 22 attached to the tabs 34 of the first polarity electrodes 24 and a second metallic separation device (not shown) attached to the tabs of the second polarity electrodes 26. In the following description, only the first separation device 22 attached to the tabs 34 of the first polarity electrodes 24 will be described in detail. However, it is understood that the second separation device is similarly attached to the tabs of the second polarity electrodes 26.

According to the invention, the first metallic separation device 22 is interposed between each pair of adjacent tabs 34 of the first polarity electrodes 24, here negative. More particularly, the first separation device 22 is arranged in each gap 60 delimited between two adjacent tabs 34.

The first separation device 22 is attached to at least one of the tabs 34 of the electrodes 24 of each of the adjacent pairs of electrodes 24.

Alternatively, the first separation device 22 is attached to each of the tabs 34 of the electrodes 24 of each of the adjacent pairs of electrode 24.

In the embodiment shown in FIGS. 3 and 4, the first separation device 22 is welded to the tab(s) of each adjacent pair of electrodes 24, by at least one weld 66 (FIG. 4).

The weld 66 is, for example, a laser weld or an ultrasonic weld.

The first separation device 22 then electrically connects together the plurality of electrical connection tabs 34 of the first polarity electrodes 24.

Alternatively (not shown), the separation device 22 is bonded to the tab(s) of each adjacent pair of electrodes 24 by means of an adhesive.

The adhesive is, for example, polyvinylidene fluoride (PVDF).

The first separation device 22 extends, between the tabs 34 of each pair of adjacent electrodes 24, between a lower edge 68 and an upper edge 70 according to the vertical direction V.

Each upper edge 70 of the first separation device 22 extends between the upper edges 54 of two adjacent tabs 34 according to the stacking direction E.

The first separation device 22 is arranged at a distance from the collectors 30, 36 of the first polarity electrodes 24 and the second polarity electrodes 26, above the collectors 30, 36, according to the vertical direction, to avoid contact with the layers 32 including the active material and the second polarity electrodes 26.

According to the invention, the upper edges 70 of the first separation device 22 are substantially flush with the upper edges 54 of the electrical connection tabs 34 of the plurality of first polarity electrodes 24.

By “substantially”, it is understood that the difference in height between the upper edges 54 of the electrical connection tabs 34 and the upper edges 70 of the first separation device 22, taken according to the vertical direction, is between 0 mm and 0.5 mm.

In other words, the upper edges 70 of the first separation device 22 and the upper edges 54 of the tabs 34 extend substantially in the same plane P, substantially parallel to the stacking direction E.

The width of the first separation device 22 taken according to the stacking direction E between two adjacent electrical connection tabs 34 is, for example, between 60% and 90% of the width of the gap 60.

Advantageously, the first separation device 22 is in contact with the tab 34 adjacent to the tab 34 to which the first separation device 22 is attached. In other words, the sum of the widths of the first separation device 22 between two adjacent connecting tabs 34 and of the weld or welds 66 is substantially equal to the width of the gap 60. In other words, the first separation device 22 is attached to the first face 56 of a tab 34 and is in contact with the second face 58 of the adjacent tab 34.

In the illustrated example, the first separation device 22 is formed by a continuous metal strip 72 successively surrounding, according to the vertical direction, the first lateral edge 50 of an electrical connection tab 34 and the second lateral edge 52 of an adjacent electrical connection tab 34.

The first electrical connector 18 comprises at least one substantially flat lower face welded to the upper edges 70 of the first separation device 22 and to the upper edges 54 of the electrical connection tabs 34 of the first polarity electrodes 24.

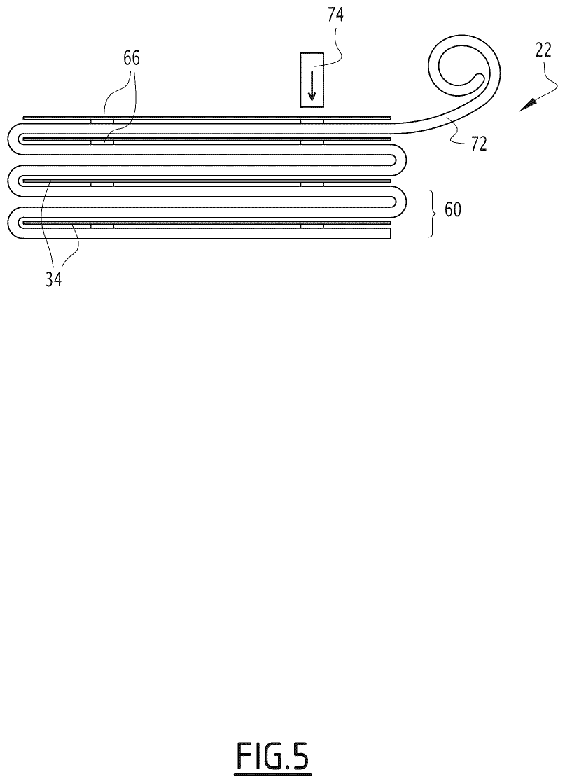

A method for manufacturing the electrochemical bundle 12 will now be described with reference to FIG. 5.

Initially, the collectors 30, 36 are manufactured by unwinding a strip of metal foil.

The metal strip is pre-coated with an ink including particularly the active material to form each electrode.

The contour of each of the collector(s) 30, 36 is obtained by stamping.

Advantageously, the ink also contains a binder and an electronic compound. The deposit forms the layer 32 including the active material.

The tabs 34 are not coated with ink including the active material.

Each stack 20 is achieved by arranging a first polarity electrode 24, here negative, facing a second polarity electrode 26, here positive, with the interposition of the first separator 28 and the second separator 29.

The stacks 20 are then stacked successively, one after the other, according to the stacking direction E.

As the stacking progresses, between two adjacent stacks 20, the first separation device 22, here the metal strip 72, is interposed between each pair of adjacent electrical connection tabs 34.

The first separation device 22 is then attached to at least one of the tabs 34 of the two adjacent electrodes 24 so that the upper edge 70 of the first separation device 22 is substantially flush with the upper edges 54 of the adjacent electrical connection tabs 34. Fixing is advantageously achieved by ultrasonic welding using a sonotrode 74.

For example, the cross-section of the head of the sonotrode 74 is between 2 mm and 4 mm.

Preferably, one or more welds, substantially spot welds, are made between the first separation device 22 and the tab 34. Alternatively, a weld bead is formed between the first separation device 22 and the tab 34.

The welded cross-section on each tab 34 is, for example, between 1 mm² and 10 mm², preferably at least 2 mm². The welded cross-section is chosen so as to ensure good mechanical strength between the components.

In the example shown, the electrical connection tabs 34 are wrapped with the continuous metal strip 72 by successively wrapping, according to the vertical direction V, the first lateral edge 50 of one tab 34 and the second lateral edge 52 of the adjacent tab 34.

The manufacturing method has been described here for the electrical connection tabs 34 of the electrodes of first polarity 24, here negative. It is understood that a similar method is used to attach the second separation device to the electrical connection tabs of the electrodes of the second polarity 26 here, positive.

A method for manufacturing a battery cell 10 as described above will now be described.

The electrochemical bundle 12 manufactured such as above is inserted into the internal volume of the cup.

The first electrical connector 18 is then welded to the upper edges 54 of the electrical connection tabs 34 of the first polarity electrodes 24 and to the upper edges 70 of the first separation device 22.

Preferably, the same is done for the second electrical connector 19 by welding it to the upper edges of the electrical connection tabs of the second polarity electrodes 26 and to the upper edges of the second separation device.

The cover 14 fitted with the terminals 16, 17 is positioned above the cup so that the terminals 16, 17 are in electrical contact with the first electrical connector 18 and the second electrical connector 19 respectively.

Thus, the upper edges 54 of the tabs 34 and the upper edges 70 of the first separation device 22, arranged substantially in the same plane, facilitate welding of the first electrical connector 18.

Unlike the battery cell 100 of the prior art, shown in FIG. 1, there is no need here to bend the tabs inside the cup, which minimizes the risk of short circuits in the bending area due to contact between the first and second polarity electrodes.

Furthermore, as there is no need to bend the tabs, the height of the tabs 34 of the bundle 12 according to the invention is relatively shorter than the tabs of the prior art. For a same cup, it is thus possible to increase the size of the electrode collectors coated with the active material, and thus to increase the capacity of the battery cell. For the same cup size, the relative gain in capacity between a battery cell 100 of the state of the art and a battery cell 12 according to the invention is between 5% and 8%.

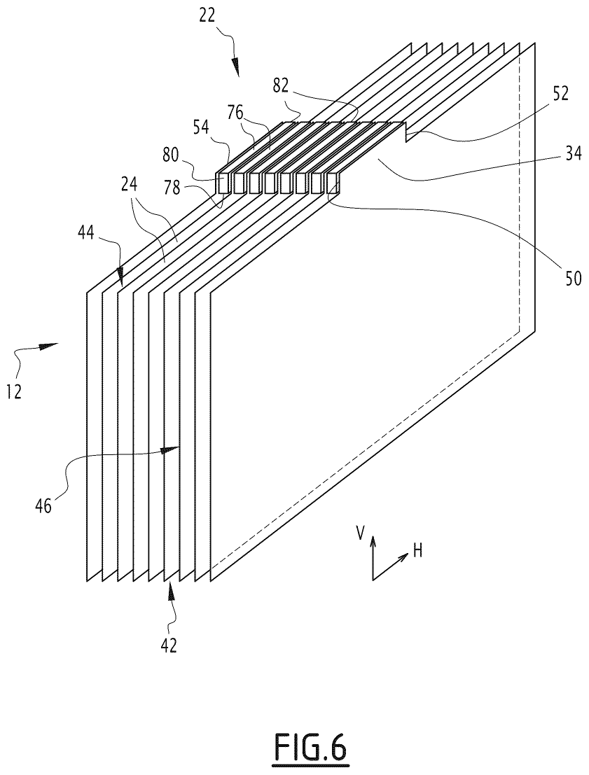

A second embodiment of the invention will now be described by differences relative to the first embodiment, with reference to FIG. 6.

In this embodiment, the first separation device 22 and the second separation device are each formed by a plurality of separation members 76 distinct from one another. Each separation member 76 of the first separation device 22 is interposed between each pair of adjacent connecting tabs 34.

The separation members 76 are preferably all identical to each other.

Each separation member 76 extends vertically between a lower edge 78 and an upper edge 80. It extends horizontally between a first lateral edge 82 and a second lateral edge 84. The first lateral edge 82 and the second lateral edge 84 connect the upper edge 80 and the lower edge 78.

For example, the length of each separation member 76 taken according to the horizontal direction H between the first lateral edge 82 and the second lateral edge 84 is between 50% and 100% of the length of the tabs 34 taken according to this same direction.

Preferably, the length of each separation member 76 is substantially equal to the length of each of the tabs 34.

The methods for manufacturing the electrochemical bundle 12 and the associated battery cell 10 are identical to those methods described above.

In one alternative to the above-described embodiments, the cup is replaced by a flexible pouch containing the electrochemical bundle(s) described above.

It follows from the above that the separation device 22, in particular the metal strip 72, is advantageously made of solid metal, in other words, free of macroscopic porosity (for example, pore size greater than 50 μm).

The separation device 22 is, for example, copper, stainless steel, nickel or aluminum, depending on the polarity of the electrode.

Advantageously, the separation device 22 presents a thickness ranging from 10 μm to 100 μm.

1. An electrochemical bundle comprising a plurality of stacks stacked according to a stacking direction,
each stack including a first polarity electrode, a second polarity electrode, a first separator and a second separator, the second polarity electrode being interposed between the first separator and the second separator, the second separator being interposed between the first polarity electrode and the second polarity electrode,
the first polarity electrode comprising a flat collector, an electrical connection tab and a layer including an active material covering at least one face of the collector,
the electrical connection tab being without a layer including the active material, and the electrical connection tab projecting from an upper edge of the collector, the electrical connection tab extending between the upper edge edge of the collector and an upper edge according to a vertical direction substantially perpendicular to the stacking direction,
the electrochemical bundle further comprising a first metallic separator interposed between each pair of adjacent electrical connection tabs according to the stacking direction, the first separator being attached to at least one of said electrical connection tabs,
the first separator extending, between each pair of adjacent electrical connection tabs, between a lower edge and an upper edge according to the vertical direction,
the upper edges of the first separator being substantially flush with the upper edges of the electrical connection tabs of the first polarity electrodes.

2. The electrochemical bundle according to claim 1, wherein a height of the electrical connection tab taken relative to the upper edge of the collector is less than 5 mm.

3. The electrochemical bundle according to claim 1, wherein each pair of adjacent electrical connection tabs delimit between them a gap receiving the first separator, a width of the first separator between the adjacent electrical connection tabs, taken according to the stacking direction, being at least equal to 60% of a width of the gap.

4. The electrochemical bundle according to claim 1, wherein the lower edges of the first separators are arranged at a distance, according to the vertical direction, from the upper edges of the collectors of the first polarity electrodes of the plurality of stacks.

5. The electrochemical bundle according to claim 1, wherein the first separator is welded to the electrical connection tab by at least one weld.

6. The electrochemical bundle according to claim 5, wherein the weld is a laser weld or an ultrasonic weld.

7. The electrochemical bundle according to claim 1, wherein each electrical connection tab extends between a first lateral edge and a second lateral edge according to a horizontal direction substantially perpendicular to the vertical direction and the stacking direction, the first separator being a continuous metal strip successively surrounding the first lateral edge of at least one of the electrical connection tabs and the second lateral edge of an adjacent electrical connection tab adjacent to the at least one of the electrical connection tabs.

8. The electrochemical bundle according to claim 1, wherein the first electrical separator comprises a plurality of metallic separation members, distinct from one another, interposed respectively between each pair of adjacent electrical connection tabs, each separation member extending between a lower edge and an upper edge according to the vertical direction, the upper edges of the first separator being formed by the upper edges of the plurality of separation members.

9. A battery cell comprising:
a cup or pouch delimiting an internal volume,
at least one electrochemical bundle according to claim 1, arranged within the internal volume,
at least one first electrical connector welded to at least one of the upper edges of the electrical connection tabs of the first polarity electrodes and to at least one of the upper edges of the first separators.

10. An electrochemical bundle manufacturing method, comprising:
successively depositing the stacks according to the stacking direction,
interposing the first separator between each pair of adjacent electrical connection tabs,
attaching the first separator to at least one of said electrical connection tabs,
the plurality of upper edges of the first separator being substantially flush with the upper edges of the electrical connection tabs of the first polarity electrodes.

11. The electrochemical bundle manufacturing method according to claim 10, wherein attaching the first separator to the electrical connection tab is carried out by welding.

12. A battery cell manufacturing method, comprising:
manufacturing an electrochemical bundle according to claim 10,
inserting the electrochemical bundle into an internal volume of a cup or pouch,
welding at least one first electrical connector to at least one of the upper edges of the electrical connection tabs of the first polarity electrodes and to at least one of the upper edges of the first separator.

13. The electrochemical bundle according to claim 2, wherein a height of the electrical connection tab taken relative to the upper edge of the collector is between 1 mm and 5 mm.
